(19) United States
(12) Patent Application Publication
(10) Pub. No.: US 2006/0285348 A1
(43) Pub. Date: Dec. 21, 2006

(54) Vehicular light assembly

(76) Inventors: David J. Valcamp, Ontario (CA); Christopher H. Wilson, Ontario (CA); Steve L. Ganado, Belleville Ontario (CA); Michael J. Bedore, Ontario (CA)

Correspondence Address: CLARK HILL, P.C., 500 WOODWARD AVENUE, SUITE 3500, DETROIT, MI, 48226, US

(21) Appl. No.: 10/571,213

(22) PCT Filed: Sep. 1, 2004
(86) PCT No.: PCT/CA04/01587

§ 371 Date: Mar. 9, 2006

Related U.S. Application Data
(60) Provisional application No. 60/504,935, filed on Sep. 22, 2003.

(51) Int. Cl. F21S 8/10

(52) U.S. Cl. 362/545; 362/231; 362/240; 362/243; 362/245

(57) ABSTRACT

A vehicle light assembly with an outer lens having at least two regions to be illuminated and employing semiconductor light sources arranged into at least two lighting circuits, a different lighting circuit illuminating each region and the light sources in one lighting circuit being mounted on an opposite side of a planar mount in the light assembly from the light sources in the other lighting circuit. A reflector is provided in the assembly housing, either as a separate body or as an integrally formed surface, and includes a first array of reflecting surfaces inclined to direct light from the light sources in the first lighting circuit through a first region of the outer lens and a second array of reflecting surfaces inclined to direct light from the light sources in the second lighting circuit through a second region of the outer lens. Light sources whose emitted light is absorbed by the outer lens to a larger degree than other light sources in the assembly can have an array of collimating lenses placed in the light path to improve their efficiency.

### FIELD OF THE INVENTION

The present invention relates to a light assembly for a vehicle. More specifically, the present invention relates to a light, for vehicles such as automobiles or trucks, such as a taillight, employing semiconductor devices, in novel configurations, as light sources.

### BACKGROUND OF THE INVENTION

Indicator and safety lighting for vehicles is an important area of development. While such systems are well known, improvements to safety, cost, reliability and aesthetic design continue to be made.

In many modern vehicles, taillight assemblies and the like are multi-functional units incorporating stop lamps, turn signal lamps, brake lamps, etc. In such assemblies, multi-colored lenses are often produced with the portions of the lens representing the turn signals being yellow plastic and the portions representing the brake lamps being red plastic. Light from incandescent bulbs is filtered as it travels through the colored plastic portions so that the emitted light is in the desired wavelengths. Unfortunately, this results in taillights and other light assemblies with multicolor external lenses which can be undesired aesthetically.

More recently, the incandescent light sources previously employed have been replaced by semiconductor devices, such as light emitting diodes (LEDs). LEDs offer advantages over incandescent lamps in that they are more power efficient, requiring less power to generate the same amount of light as an incandescent lamp. Moreover, LEDs provide significant improvements in the amount of time it takes to provide illumination, the “on” time, as compared to an incandescent bulb thus providing other drivers with more time to react to certain driving situations.

Semiconductor light sources like LEDs typically are also smaller than comparable incandescent lamps, generate less waste heat due to their higher efficiencies and the resulting light assemblies can be designed to occupy less volume than would be the case with incandescent bulbs. Further, semiconductor light sources have longer lifetimes than incandescent bulbs which enhances the reliability of the lighting in the vehicles they are employed in.

However, unlike incandescent bulbs which disperse their light broadly, LEDs are much like point sources of light in that their light is emitted from a very small area (the semiconductor junction(s)). Further, in many cases the package that the LED is fabricated in, typically an epoxy body, does not diffuse the emitted light but instead usually includes a collimating lens of some form to direct the emitted light in a particular direction.

This fact can make it difficult to provide the desired aesthetic appearance of the light produced by light assemblies employing such LED light sources. Typically, lighting designers address this deficiency in semiconductor-based light assemblies by employing many more light sources than would other wise be required merely to produce the required amount of light and the designers include additional optical components, such as diffusing lenses, in an attempt to provide a more uniform lit appearance.

More recently, relatively high intensity semiconductor light sources have become available. While this has provided light assembly designers additional aesthetic tools, the above-mentioned problems can be exacerbated. As specified by various respective automotive safety regulating bodies, the area of a particular lighting function (i.e. a turn signal or brake light) must be at least a minimum size despite the fact that the number of LEDs required to provide the required illumination has decreased. Thus, it has become still more difficult to disperse the light from fewer LEDs over the same amount of area in a manner which is still aesthetically pleasing.

U.S. Pat. No. 4,929,866 to Murata et al. shows a prior art attempt to provide an evenly illuminated automotive light employing LEDs. The LEDs are positioned between the lens of the taillight and a reflector such that the majority of light emitted by the LEDs is emitted perpendicular to the lens of the taillight. The reflector has a staircase arrangement of parallel elongate reflecting faces which extend orthogonally to the direction in which light is emitted from the LEDs and the emitted light shines off the reflecting faces which are angled to reflect the light out through the lens. While the taillight taught by Murata offers some advantages over prior attempts which employed diffusers, it suffers from the fact that it only works for relatively flat lighting assemblies which limits the aesthetic designs which can be produced.

Given the shape of modern cars, taillights are typically required to be located in locations on the vehicle such that the outer lens must curve around a significant portion of the rear corner of the vehicle. When such a taillight employs LEDs, the designer is typically faced with the challenge of forming the electrical circuit, of which the LEDs are part, in such a way that the light emitted from the taillight travels in the approximate longitudinal direction of the vehicle. In the past this has been accomplished through the use of multiple circuit boards which can be positioned at differing angles and then tied together electrically or by using a circuit that can be formed with multiple offset steps. While such prior art solutions have been effective at approximating the curvature of the vehicle, these multiple circuit solutions are typically very expensive and/or laborious to install into the light assembly.

It is desired to have a light assembly which employs semiconductor light sources, which provides a reasonably dispersed, even light without requiring excessive numbers of light sources and which can be configured in a variety of shapes.

### SUMMARY OF THE INVENTION

It is an object of the present invention to provide a novel vehicular light assembly employing semiconductor devices which obviates or mitigates at least one disadvantage of the prior art.

According to a first aspect of the present invention, there is provided a vehicular light assembly comprising: a housing for attachment to a vehicle; an outer lens having at least first and second regions to be illuminated; a generally planar mount having semiconductor light sources mounted on first and second opposed sides to form at least a first lighting circuit on the first opposed side and at least a second lighting circuit on the second opposed side, the planar mount being mounted in the housing behind the outer lens; and a reflector in said housing comprising a first array of reflecting surfaces inclined to the plane of the planar mount to direct light from the light sources in the first lighting circuit through a first region of the outer lens and further comprising a second array of reflecting surfaces inclined to the plane of the planar mount to direct light from the light sources in the second lighting circuit through a second region of the outer lens.

Preferably, the light assembly further includes a plurality of collimating lenses spaced correspondingly to a plurality of the light sources in the second lighting circuit and being disposed between the light sources and the reflecting surfaces of the second array of reflecting surfaces to focus the light from the second lighting circuit light sources onto the second region of the lens. Also preferably, the light sources of the second lighting circuit emit light of a wavelength different than the light emitted by the light sources of the first lighting circuit. The outer lens is relatively transparent to light of the wavelength emitted by the light sources of the first lighting circuit and less transparent to light of the wavelength emitted by the light sources of the second lighting circuit but still allowing a large proportion of light of the second wavelength to pass through the second region of the outer lens thus altering the apparent color of the second region when the second lighting circuit is illuminated. In other words, the outer lens is relatively transmissive, allowing the second wavelength to pass without affecting the wavelength, thereby maintaining the second wavelength and color. Also preferably, the wavelength emitted by the light sources of the first lighting circuit corresponds to light of the color red and the wavelength emitted by the light sources of the second lighting circuit corresponds to light of the color amber and the color of the outer lens is red, where the apparent color of the second region when the second lighting circuit is illuminated is amber and, when the second lighting circuit is not illuminated, the color of the second region is red.

Also preferably, the outer lens is curved through a plane orthogonal to the plane of the planar mount upon which the light sources are mounted. In another embodiment, the reflector can be integrally formed within the housing.

The present invention provides a vehicle light assembly with an outer lens having at least two regions to be illuminated, the semiconductor light sources being arranged into at least two lighting circuits, a different lighting circuit illuminating each region and the light sources in one lighting circuit being mounted on an opposite side of a planar mount in the light assembly from the light sources in the other lighting circuit.

### BRIEF DESCRIPTION OF THE DRAWINGS

Preferred embodiments of the present invention will now be described, by way of example only, with reference to the attached Figures, wherein:

FIG. 1 shows a section through a taillight assembly in accordance with an embodiment of the present invention;

FIG. 2a shows a front view of a portion of a reflector and light source mount of the taillight assembly of FIG. 1;

FIG. 2b shows a side view of a portion of a reflector and light source mount of the taillight assembly of FIG. 1;

FIG. 2c shows a top view of a portion of a reflector and light source mount of the taillight assembly of FIG. 1;

FIG. 3 shows a top view of a section through a portion of the reflector of the taillight assembly shown in FIG. 1;

FIG. 4 shows a perspective view of the taillight assembly of FIG. 1 with an outer lens removed; and

FIG. 5 shows an array of collimating lenses.

### DETAILED DESCRIPTION OF THE INVENTION

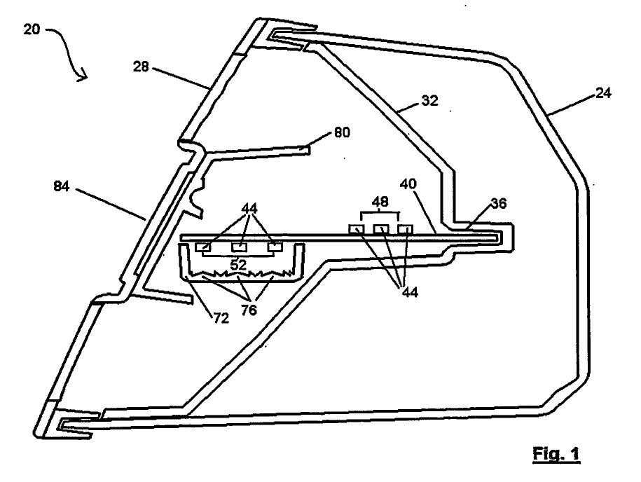

An automotive taillight assembly in accordance with an embodiment of the present invention is indicated generally at 20 in FIG. 1. Taillight assembly 20 includes a housing 24, which can be formed of ABS plastic or any other suitable material as will be apparent to those of skill in the art and an outer lens 28 which is formed of a transparent material, such as acrylic or any other suitable material as will also be apparent to those of skill in the art and which may be colored as desired.

A reflector 32, described in more detail below, is mounted inside housing 24 and includes a slot 36 in which a planar light source mount 40 is inserted. While not shown in FIG. 1, slot 36 can also extend around the inner sides of housing 24 to receive and further support the two ends of mount 40. Mount 40 can be any suitable substrate such as plastic or aluminum on which a plurality of semiconductor light sources, such as LEDs 44, can be mounted.

As shown in the Figure, a first plurality of LEDs 44 are mounted on an upper side of mount 36 and are electrically connected to form a first lighting circuit 48 and a second plurality of LEDs are mounted on the lower side of mount 40 and are electrically connected to form a second lighting circuit 52. As will be apparent to those of skill in the art, lighting circuits 48 and 52 can, if necessary, contain other electrical components, not shown, such as current limiting resistors, etc.

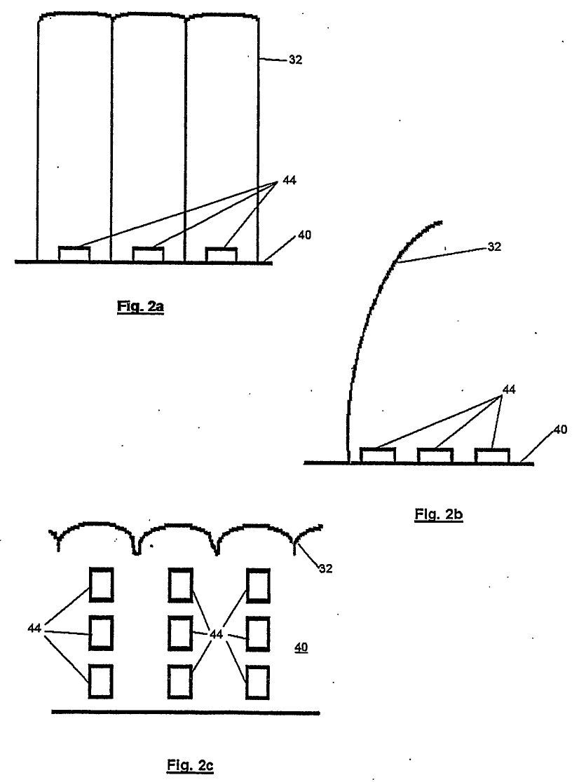

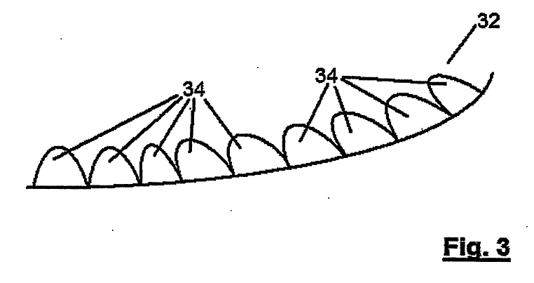

Referring now to FIGS. 2a, 2b, 2c and 3, reflector 32 is shown in more detail. As shown, in the illustrated embodiment, LEDs 44 are arranged in groups of three and reflector 32 includes a reflecting surface 34 for each group. In the illustrated embodiment, each surface 34 is convex in shape facing towards LEDs 44, as best seen in FIG. 2c. As shown in FIG. 2b, reflector 32 also curves inwardly toward LEDs 44, as it extends upward from mount 40. As will be apparent to those of skill in the art, surfaces 34 need not be convex in shape and can, for example, merely be inclined and/or curved planar surfaces, as long as the design of surfaces 34 in reflector 32 direct the light emitted by LEDs 44 towards outer lens 28. Surfaces 34 direct the light emitted by LEDs 44 in a manner which provides generally even lighting across outer lens 28.

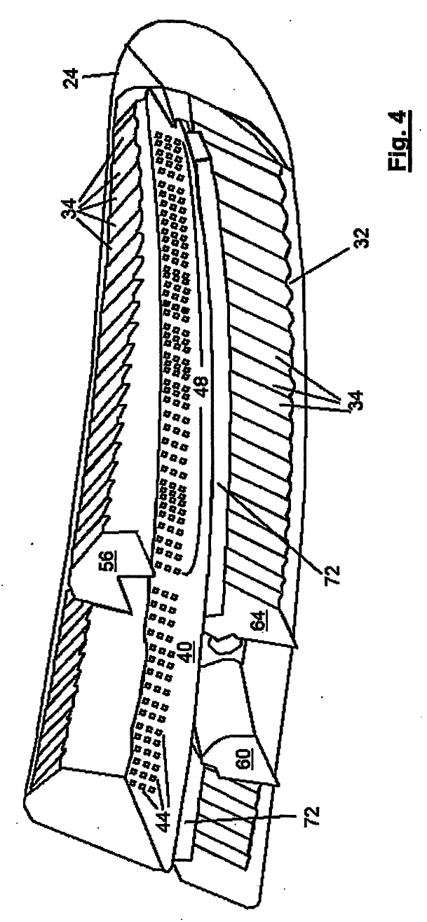

A particular advantage of the design of reflector 32 over that taught in Murata, as discussed above, is that reflector 32 need not be flat and orthogonal to the direction of emitted light and this allows taillight assembly 20 to be shaped in a variety of aesthetically pleasing designs. As an example, as can be seen in FIG. 4 the right hand side of taillight assembly 20 is swept back from the left hand side and FIG. 3 shows a section through reflector 32 to better illustrate the sweeping back of the right hand side of taillight assembly 20.

Another advantage of the present invention is that reflector 32 can be relatively inexpensively manufactured from metalized molded plastic and the reflector surfaces 34 for both the light sources above and below mount 40 can be fabricated as a single reflector unit 32. Alternatively, housing 24 can be manufactured from molded plastic with reflector 32 integrally formed in the interior. Reflector 32 can then be chromed, or otherwise made reflective, by conventional methods including vapor deposition or electrodeposition of metal.

Another feature of tail light assembly 20, is the mounting of LEDs 44 on both the top and bottom surfaces of mount 40, as shown in FIG. 1. By employing both surfaces of mount 40 to hold LEDs 44, a more compact taillight assembly 20 can be obtained and mount 40 itself can act as a shroud between different regions (upper and lower in the illustrated example) to be illuminated on outer lens 28. In the illustrated embodiment of FIG. 4, the volume above mount 40 is divided, left from right, by a shroud 56 to form two different regions to be illuminated, the region to the left of shroud 56 being a region corresponding to a running light and the region to the right of shroud 56 corresponding to a brake light.

The volume below mount 40 is divided into three regions. The left hand most region in FIG. 4 corresponds to a rear fog warning light (required in some European jurisdictions) which is separated from the right hand most region, which corresponds to a turn signal, by a mid-region formed by a pair of shrouds 60 and 64 between which a conventional incandescent bulb (not shown) is located to define a back up, or reversing, light region.

The semiconductor light sources, such as LEDs 44, in each region are formed into separate lighting circuits by electrical conductors (not shown) which are also mounted to mount 40. In a present embodiment, LEDs 44 are mounted to a flexible substrate which also carries the necessary electrical conductors, and any other necessary components such as current limiting resistors (not shown), and the substrate is bonded to mount 40 using an adhesive. The present invention is not limited to this technique for mounting and connecting LEDs 44 and a variety of other techniques, including fabricating mount 40 as a conventional or surface mount printed circuit board, can be employed as will be apparent to those of skill in the art.

Another advantage afforded by the present invention is the provision of different colored emitted light in various illuminated regions with a single color outer lens 28. As mentioned above, various automotive standards and/or safety regulations require specific colors to used for specific lights. For example, brake lights are typically required to be red and turn signals are typically required to be amber. For aesthetic reasons, many automotive designers dislike the multicolored outer lenses which typically are required to meet these regulations.

European Patent EP 0 689 000 B1 to Neytcheva teaches a taillight system which has an outer lens of red. The taillight employs LEDs which emit a relatively narrow band of red light to provide the necessary red light for brake lights, etc. and employs LEDs that emit a narrow band of amber light to provide the necessary amber light for turn signals. While the outer lens taught by Neytcheva is red in color, it does pass the amber light emitted by the amber LEDs, without color change, although some of the emitted light is absorbed by the outer lens.

While the taillight taught by Neytcheva does allow improved aesthetic designs, it suffers from the fact that an excessive number of amber emitting LEDs must be employed to achieve the required intensity of amber light due the absorption of some of the amber light by the outer lens. In contrast, the present inventors have determined that by providing a collimating lens, such as a Fresnel lens, in the light path of each amber emitting LED in the present invention, the required intensity level of amber light passing through outer lens 28 can be achieved with a lesser number of amber emitting LEDs.

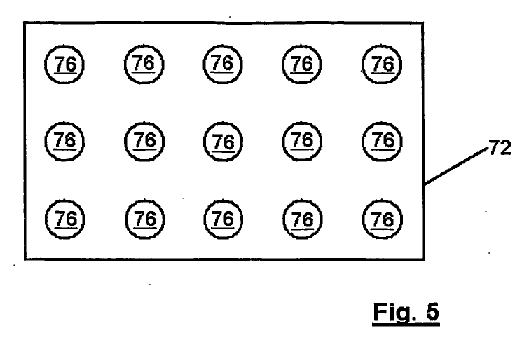

FIG. 5 shows an array 72 of collimating lenses 76. Array 72 can be fabricated in a variety of manners and, in a present embodiment, array 72 is fabricated by injection molding a suitable material such as transparent acrylic. Array 72 is mounted on mount 40 between LEDs 44 and reflector 32 and each collimating lens 76 is spaced in array 72 such that, when array 72 is mounted in position, as shown in FIG. 1, a collimating lens 76 is centered over each LED 44. By collimating the amber light emitted by the LEDs 44 with lenses 76 before the light is reflected by reflector 32, a larger percentage of the light emitted by the amber LEDs 44 is directed onto the surfaces 34 of reflector 32 and thus more of the amber light is directed through outer lens 58. As will be apparent to those of skill in the art, the present invention is not limited to providing red and amber light through a red outer lens 28 and a variety of other color combinations can be employed, if desired.

Additional aesthetic features can also be included with taillight assembly 20. For example, a bezel 80 can be mounted to the interior of outer lens 28 occluding a portion of the taillight assembly 20, such that anyone looking into taillight assembly 20 will have an obstructed sight line to LEDs 44 on mount 40. Further, a trim piece may be attached to the exterior of outer lens 28 in recess 84.

The present invention provides a taillight assembly with many features and advantages. The assembly is compact and yet provides multiple different illuminated regions and also provides both amber and red illuminated regions through a single color (for example red) outer lens in a reasonably efficient manner by using collimating lenses between the reflector and the LEDs whose emitted light is absorbed to a greater degree by the outer lens. The assembly can be manufactured in variety of shapes, due to its novel reflector design, to meet the aesthetic needs of vehicle designers.

The above-described embodiments of the invention are intended to be examples of the present invention and alterations and modifications may be effected thereto, by those of skill in the art, without departing from the scope of the invention which is defined solely by the claims appended hereto.

We claim:

1. A vehicular light assembly comprising:
a housing for attachment to a vehicle;
an outer lens having at least first and second regions to be illuminated;
a generally planar mount having semiconductor light sources mounted on first and second opposed sides to form at least a first lighting circuit on the first opposed side and at least a second lighting circuit on the second opposed side, the planar mount being mounted in the housing behind the outer lens; and
a reflector in said housing configured to direct light from the light sources in the first lighting circuit through the first region of the outer lens and further configured to direct light from the light sources in the second lighting circuit through the second region of the outer lens.

2. The vehicular light assembly of claim 1, wherein said reflector comprises a first array of reflecting surfaces inclined to the planar mount and a second array of reflecting surface inclined to the planar mount.

3. The vehicular light assembly of claim 2, further comprising an array of collimating lenses spaced correspondingly to a plurality of the light sources in the second lighting circuit and being disposed between the light sources and the second array of reflecting surfaces to focus the light from the second circuit light sources onto the second region of the lens.

4. The vehicular light assembly of claim 3 wherein the light sources of the first lighting circuit emit a narrow band of light of a first wavelength and the light sources of the second lighting circuit emit a narrow band of light of a second wavelength different than the first wavelength, the outer lens being relatively transmissive to light of the second wavelength, sustaining said second wavelength.

5. The vehicular light assembly of claim 4 wherein the first wavelength corresponds to the color red and the second wavelength corresponds to the color amber and the color of the outer lens is red.

6. The vehicular light assembly of claim 5 wherein the reflector is integrally formed within said housing and has a reflective coating applied to it.

7. The vehicular light assembly of claim 1 wherein the light sources of the first lighting circuit emits red light and the light sources of the second lighting circuit emits amber light and the color of the outer lens is red.

8. The vehicular light assembly of claim 7 further comprising a collimating lens positioned to collimate said amber light.

9. The vehicular light assembly of claim 8 wherein said collimating lens is positioned between the second lighting circuit and the reflector.

10. The vehicle light assembly of claim 7 further comprising an array of collimating lenses positioned to collimate light from each of the light sources of the second lighting circuit.

11. The vehicle light assembly of claim 10 wherein said array of collimating lenses are positioned between the second lighting circuit and the reflector.

12. The vehicle light assembly of claim 11 wherein said array of collimating lenses are integrally formed.

13. The vehicle light assembly of claim 1 further comprising a bezel positioned between the outer lens and the planar mount occluding at least said first lighting circuit.

14. The vehicle light assembly of claim 13, further comprising an array of collimating lenses mounted on said planar mount collimating light from each of the light sources of said second lighting circuit.

15. A vehicle light assembly comprising:
a housing;
an outer lens mounted to said housing and having at least two regions to be illuminated;
a relatively planar member having first and second opposed sides mounted in said housing;
a plurality of semiconductor light sources being arranged into two lighting circuits; and
a reflector in the housing, said reflector reflecting light from said light sources towards said outer lens, characterized by one lighting circuit to illuminate each region of the outer lens and the light sources in one lighting circuit being mounted on the first opposed side of the planar member and the light sources in the second lighting circuit being mounted on the second opposed side of the planar member.

16. The vehicle light assembly of claim 15, wherein said reflector comprises a first array of reflecting surfaces inclined to the planar member reflecting light from the first lighting surfaces to a first region of the outer lens and a second array of reflecting surfaces inclined to the planar member reflecting light from the second lighting surfaces to the second region of the outer lens.

17. The vehicular light assembly of claim 16, further comprising an array of collimating lenses mounted on said planar member collimating light from each of the light sources of said second lighting circuit and directing said collimated light towards said array of reflecting surfaces.

18. The vehicle light assembly of claim 17 further comprising a bezel positioned between the outer lens and the planar member occluding a direct view ofat least said first lighting circuit.

19. The vehicle light assembly of claim 18 wherein said collimating lenses are integrally formed.

20. The vehicular light assembly of claim 19 wherein the light sources of the first lighting circuit emits a narrow band of red light and the second lighting circuit emits a narrow band of amber light and the color of the outer lens is red.

21. The vehicle light assembly of claim 20 wherein said light sources are light emitting diodes.
